(19) United States
(12) Patent Application Publication
(10) Pub. No.: US 2014/0310041 A1
(43) Pub. Date: Oct. 16, 2014

(54) SCHEDULING SYSTEM AND METHOD FOR DISTRIBUTION OF PERISHABLE LOADS OF PRE-MIXED CONCRETE TO MULTIPLE SITES

(71) Applicant: Command Alkon Incorporated, Birmingham, AL (US)

(72) Inventors: David L. Crocker, Birmingham, AL (US); Andrew M. Dyment, Dundas (CA)

(21) Appl. No.: 14/310,724

(22) Filed: Jun. 20, 2014

Related U.S. Application Data
(63) Continuation-in-part of application No. 13/754,242, filed on Jan. 30, 2013.

(51) Int. Cl. G06Q 10/06; G06Q 10/08

(52) U.S. Cl. CPC G06Q 10/063114; G06Q 10/083
USPC 705/7.15

(57) ABSTRACT

Disclosed herein are systems and methods for a performance evaluation and feedback system for drivers of concrete delivery trucks. Because concrete delivery is time sensitive, driver performance should be measured in part on the time required to perform various tasks, yet current methods do not allow for such evaluation. The method disclosed herein is performed by a system to provide real-time evaluation and performance data to drivers and dispatchers to improve delivery time, and to allow for increased feedback and data quantity for driver review.

### CROSS-REFERENCE TO RELATED INVENTIONS

This patent application is a continuation-in-part of U.S. patent application Ser. No. 13/754,242, filed on Jan. 30, 2013, and which is currently pending.

### FIELD OF THE INVENTION

This invention relates generally to a method and a system for scheduling and distributing multiple dispersed perishable loads of pre-mixed concrete to multiple different delivery sites. Additionally, the invention is related generally to performance measurements and feedback, and in particular to driver performance measurement and feedback for concrete delivery.

### BACKGROUND ART

Various scheduling models for route and delivery planning are well known in the art. For example, the traveling salesman problem, wherein the optimal path for a single person traveling once to each of multiple destinations, is a well-known optimization problem with many known methods for solving the problem. By determining a relationship between routes and cost, or route and time, the model can also determine cost- or time-efficient paths. However, these methods involve a single traveler visiting multiple destinations exactly one time.

Other scheduling models involve multiple traveling or delivery units traveling to multiple destinations. For example, known methods in the art, such as parcel delivery or food delivery, require each destination be visited only once, by one of multiple possible delivery units. Furthermore, once the delivery units leave the loading station (for example, the post office or the restaurant), each unit travels from delivery point to delivery point along its assigned route. In these instances, the scheduling model determines which parcels should be delivered by which unit, and then each independent unit travels on its own delivery route. In essence, once the parcels are distributed to the specified delivery unit, the delivery unit follows its own predetermined route, determined in the same manner as solving a traveling salesman problem. None of these methods, however, address the issue of when any of multiple delivery units may be sent to a particular destination even after receiving their loads. They also lack the ability to account for loading the delivery unit at one of multiple sites, or for the possibility of repeated returns to one or more alternative load sites. In addition, these methods lack the flexibility to reassign delivery units already in transit to their destinations, which may occur when there is a need to send multiple delivery units to the same destination, to divert a delivery unit from one destination to another, or to add or remove a delivery site for a particular delivery unit to account for changes made to others' schedule or estimated time of arrival. This flexibility requires accounting for different scheduling factors and methods than those currently known in the art.

Other scheduling methods known in the art are capable of sending multiple mobile units (for example, repairmen) to some or all of multiple destinations. In these cases, the time for traveling to and remaining at each destination is estimated, and as a mobile unit completes its stay at one destination, it may be routed to the next on the schedule. In this manner a schedule may be established for the entire day, built forward from the first locations to which the mobile units are sent. However, these methods do not account for the possible need to send multiple mobile units to the same destination. Also, they lack the flexibility to first send the mobile unit to one of multiple load sites to pick up the load, or for the possibility of repeated returns to one of multiple load sites.

Other deficiencies will also be apparent in light of the present disclosure.

These deficiencies and other deficiencies in the prior art inhibit their use for scheduling methods for pre-mixed concrete, which is a rapidly perishable bulk commodity with multiple loading sites and multiple delivery units. Furthermore, loading sites may have differing capabilities for producing different blends of pre-mixed concrete.

Also, current practice for concrete producers is heavily focused on measuring the volume of delivered concrete product on a daily or monthly basis. Two primary measures are used: the primary measures used are volume of concrete delivered per driver hour, and the daily average number of loads delivered. However, these generally calculated as averages over a significant period of time, and therefore are lagging measures that look backward. This type of late, lagging feedback to drivers results in delayed corrective response times for drivers and ultimately results in only periodic response and correction. Since these measures represent the summary of a large number of events that occurred in the past, it is difficult to deduce direct and actionable guidance on what specific steps in the delivery process under the driver's control need improvement. While they may be able to inform the drivers that they are not meeting an arbitrary overall performance goal, it does not give clarity on specific actions or activities that are falling short of meeting expectations. Concrete producers may monitor and capture the times a driver spends in each step of the process of delivering loads of concrete. These times are captured, stored, and subsequently tabulated in reports for monthly operational reviews, but the times are often not shared with drivers. The consolidated numbers in these reports will encompass a variety of events that could positively or negatively affect the timing of delivery. Accordingly, little specific and actionable data exists to help the driver in adjusting work methods or timing for a specific delivery. No leading indicators exist to alert the driver in advance on what is the expected goal and give real time feedback on the timing or schedule during the transportation, loading, or unloading of the concrete. Instead, the sporadic and after-the-fact review of performance data with drivers often fails to provide specific and effective guidance for making improvements while in the process of making a specific delivery. As a result, many attempts at improving the conformance to delivery schedules are not successful.

What is needed is a scheduling method and system capable of dispatching any or all of several delivery units to one of several pre-mixed concrete load sites to pick up a load, routing those delivery units to at least one delivery site for delivering the loads, and then routing the delivery units to a load site to take on another concrete load and be directed again to a delivery site, wherein the scheduling method and system is responsive to real-time changes in information and data relating to delivery units, load sites, delivery sites, traffic and road information, and other relevant conditions.

What is also needed is timely and up-to-the-minute feedback to the driver indicating what the expected or allowed time is for each step in the delivery process and proving direct, real-time feedback on their progress, which may provide drivers with leading indicators derived from their activities.

### SUMMARY OF THE INVENTION

For pre-mixed concrete delivery, the scheduling method must time the arrival of concrete to a particular destination, or the arrival of multiple loads of concrete to the same destination, in order to not allow the concrete to perish or create problems with delivery or use at the destination. For example, taking too long to deliver a load will result in lost concrete due to hardening, and improper timing of multiple deliveries to a destination can cause either hardening in delivery units waiting to deliver, or alternatively, cause multiple strata of poured concrete to form at the destination if the next delivery unit is not ready to begin pouring.

Furthermore, once a delivery unit has completed a load, it may return to a load site to pick up a new load of concrete for delivery to either the same destination or a different destination, be sent home, or be sent to a place to be loaded for the next day, as will need to be determined by the scheduling model. Multiple load sites may be available for a given area, and the delivery unit may be routed to any of them, depending on factors such as the traffic conditions, the time to reach the load site, price or cost (monetary or otherwise) for taking on load at the given load site, and the amount of time it will take to pick up the load, which may vary due to both the load rate of the load site and the number of other delivery units waiting to be loaded.

Lastly, because properly timing the deliveries of rapidly perishable pre-mixed concrete is essential to lowering costs, the scheduling model must be updatable during the day to account for changing traffic conditions, changes in concrete mixing plant availability, available delivery units, and other unforeseen factors.

In some aspects, selected delivery units are dispatched to pick up a perishable load of pre-mixed concrete from one of multiple load sites and then directed to one of the multiple delivery sites. The delivery units are dispatched according to a transport itinerary determined by a central processor. The central processor, which may be a computer or a distributed server, determines the transport itineraries by processing both fixed information and dynamically variable real-time information to determine multiple possible transport itineraries, and then selecting the appropriate transport itinerary for the selected delivery units in order to achieve the lowest overall cost. The transport itineraries are updated multiple times each day, and even while delivery units are en route, to reflect changes in variable real-time information.

In other aspects, the invention relates to a process performed by a computer processor for directing a plurality of delivery units to deliver loads of pre-mixed perishable concrete to a plurality of delivery sites, wherein the load for any delivery site may be received from one of several load sites, the process having the steps of identifying delivery units available for making deliveries and a current location of each; identifying each delivery site needing one or more deliveries of concrete; identifying each load site where loads may be taken on; receiving real-time information relevant to the scheduling and routing of concrete deliveries; calculating estimated travel times and routes from the current location of delivery units to load sites, and from load sites to delivery sites based at least in part on the real-time information; removing from consideration for a particular delivery a delivery unit having travel times in excess of a perishability time limit for the load corresponding to a delivery site; processing the real-time information to assign a delivery unit to each delivery site to deliver a load of concrete in a manner that minimizes the total overall cost; assigning a transport itinerary to each delivery unit that is assigned a delivery site; and transmitting to each delivery unit the assigned transport itinerary for the particular delivery unit.

In other aspects, the invention relates to a process performed by a computer processor for directing delivery units to deliver loads to a plurality of delivery sites, wherein the load for any delivery site can come from one of several load sites, the process having the steps of identifying a plurality of delivery units; receiving real-time information relevant to the delivery of concrete; identifying within the plurality of delivery units a first subset of delivery units currently assigned transport itineraries; identifying within the first subset of delivery units a second subset of delivery units that will not deliver their assigned loads on time based on real-time information; processing the real-time information to identify a substitute delivery unit capable of delivering concrete to a delivery site at the lowest cost for each of the second subset of delivery units; assigning new transport itineraries to each substitute delivery unit, each transport itinerary denoting a load site, a delivery site, and a delivery route; and transmitting the new transport itineraries to each substitute delivery unit.

In other aspects, the invention relates to a process performed by a computer processor for directing delivery units to a plurality of load sites, such that each delivery unit may take on a load of pre-mixed perishable concrete to be delivered to a delivery site, the process having the steps of identifying a plurality of delivery units, wherein each delivery unit is traveling to a delivery site; identifying each delivery site to which each delivery unit is traveling; calculating estimated travel times and routes for each delivery unit to its corresponding load site based at least in part on real-time information; and adjusting the transport itinerary for each delivery unit based on the estimated travel times and routes.

In other aspects, the invention relates to a process for a delivery unit to receive instructions regarding the delivery of a load of pre-mixed perishable concrete from a load site to a delivery site, the process having the steps of transmitting real-time information including traffic information, delivery unit information, load site information, or delivery site information to a server; receiving a transport itinerary from the server based at least in part on the real-time information, the transport itinerary denoting load site information and delivery site information; and delivering pre-mixed perishable concrete to a delivery site identified in the delivery site information.

In other aspects, the invention relates to a process performed by a computer processor for directing delivery units to a plurality of load sites, such that each delivery unit may take on a load of pre-mixed perishable concrete to be delivered to a delivery site, the process having the steps of receiving real-time information including traffic information, delivery unit information, load site information, or delivery site information; processing the real-time information to create a revised transport itinerary; and transmitting the revised transport itinerary to the delivery unit, such that the delivery unit delivers the load to the delivery site.

In other aspects, the invention relates to a process performed by a computer processor for directing delivery units to a plurality of load sites, such that each delivery unit may take on a load of pre-mixed perishable concrete to be delivered to a delivery site, the process having the steps of transmitting transport itineraries to a plurality of delivery units; receiving real-time information including an alert regarding traffic conditions or delivery unit delivery times; processing the real-time information to create a revised transport itinerary for at least one identified delivery unit affected by the real-time information; and transmitting the revised transport itineraries to the identified delivery units.

In other aspects, the invention relates to a system for scheduling the delivery of loads carried by a plurality of delivery units from a plurality of load sites to a plurality of delivery sites, the system having a server having a processor adapted to calculate route times for delivery units to each load site and then from each load site to each delivery site and to assign a transport itinerary to delivery units in a manner that minimizes the overall cost; a transceiver that receives and transmits real-time information; and a database for storing updatable data elements and fixed information; and a plurality of delivery units, each delivery unit having a location sensor and a transceiver that wirelessly communicates with the processor.

Other aspects and advantages will be apparent from the following description and the appended claims.

### BRIEF DESCRIPTION OF DRAWINGS

It should be noted that identical features in different drawings are shown with the same reference numeral.

FIG. 1 depicts one embodiment of a system of delivery units directed to multiple load sites and delivery sites according to the disclosure.

FIG. 2 depicts one embodiment of the major features of the server hardware, according to the disclosure.

FIG. 3 depicts one embodiment of a database for storing and manipulating information according to the disclosure.

FIGS. 4A, 4B, and 4C depict various embodiments of outputs for transport itineraries transmitted to delivery units according to the disclosure.

FIG. 5 depicts the steps taken in one embodiment of a method according to the disclosure.

FIGS. 6A and 6B depict illustrative cost tables for delivering multiple loads of concrete via multiple delivery units from multiple load sites, according to an illustrative embodiment of the disclosure set forth herein.

FIGS. 7A, 7B, 7C, and 7D depict illustrative unit-versus-load matrices of costs for each delivery unit according to the illustrative embodiment set forth herein.

FIGS. 8A, 8B, 8C, and 8D depict illustrative cost-per-delivery vectors for each delivery unit according to the illustrative embodiment set forth herein.

FIG. 9 depicts the illustrative unit-cost-per-delivery matrix according to the illustrative embodiment set forth herein.

FIG. 10 is a depiction of a “Start of Day Display” prior to beginning service, in accordance with one embodiment of the disclosure.

FIG. 11 is a depiction of a “Start of Day Display” nearing the time of beginning service, in accordance with one embodiment of the disclosure.

FIG. 12 is a depiction of a “Start of Day Display” when the time for beginning service has been exceeded, in accordance with one embodiment of the disclosure.

FIG. 13 is a depiction of a query screen providing reasons for delay in beginning service, in accordance with one embodiment of the disclosure.

FIG. 14 is a process flow chart depicting the beginning of service or “in service” process, in accordance with one embodiment of the disclosure.

FIG. 15 is a depiction of a “To Job Display” after loading has completed and is inspecting the load prior to leaving for the job, in accordance with one embodiment of the disclosure.

FIG. 16 is a depiction of a “To Job Display” as the deadline to leave for the job nears, in accordance with one embodiment of the disclosure.

FIG. 17 is a depiction of a “To Job Display” after the time to leave for the job location has passed, in accordance with one embodiment of the disclosure.

FIG. 18 is a depiction of a query screen providing reasons for delay in leaving for the job location, in accordance with one embodiment of the disclosure.

FIG. 19 is a process flow chart depicting the process from end of loading to the time of leaving for the job, in accordance with one embodiment of the disclosure.

FIG. 20 is a depiction of a “Time to Pour Display” after arrival at a job location, in accordance with one embodiment of the disclosure.

FIG. 21 is a depiction of a “Time to Pour Display” as the deadline for beginning pour nears, in accordance with one embodiment of the disclosure.

FIG. 22 is a depiction of a “Time to Pour Display” after the deadline to begin pouring has passed, in accordance with one embodiment of the disclosure.

FIG. 23 is a depiction of a query screen providing reasons for delaying the beginning of the pour at the job location, in accordance with one embodiment of the disclosure.

FIG. 24 is a process flow chart depicting the process from arrival at the job location to beginning of pouring, in accordance with one embodiment of the disclosure.

FIG. 25 is a depiction of a “Time to Plant Display” after ending pour and washing to begin travel back to the concrete plant, in accordance with one embodiment of the disclosure.

FIG. 26 is a depiction of a “Time to Plant Display” as the deadline for departing to the plant nears, in accordance with one embodiment of the disclosure.

FIG. 27 is a depiction of a “Time to Plant Display” after the deadline for departing to the plant has passed, in accordance with one embodiment of the disclosure.

FIG. 28 is a depiction of a query screen providing reasons for delaying departure to the plant, in accordance with one embodiment of the disclosure.

FIG. 29 is a process flow chart depicting the process from washing to departure to the plant, in accordance with one embodiment of the disclosure.

FIG. 30 is a depiction of an “Out of Service Display” after arrival at plant, in accordance with one embodiment of the disclosure.

FIG. 31 is a depiction of “Out of Service Display” as the deadline for clocking out nears, in accordance with one embodiment of the disclosure.

FIG. 32 is a depiction of “Out of Service Display” after the deadline to clock out has passed, in accordance with one embodiment of the disclosure.

FIG. 33 is a depiction of a query screen providing reasons for delaying clocking out, in accordance with one embodiment of the disclosure.

FIG. 34 is a process flow chart depicting the process from arrival at the plant to clocking out, in accordance with one embodiment of the disclosure.

### DETAILED DESCRIPTION

An exemplary purpose of one embodiment is to dispatch multiple delivery units carrying loads of pre-mixed concrete between at least one load site and multiple delivery sites according to dynamic transport itineraries. Transport itineraries are determined by one or more servers configured to receive real-time information and process the real-time information together with known fixed information or assumptions to produce schedules according to given operator-selected constraints. The servers then transmit a transport itinerary to the selected delivery units and may be updated accordingly as the real-time information received by the server changes throughout the day.

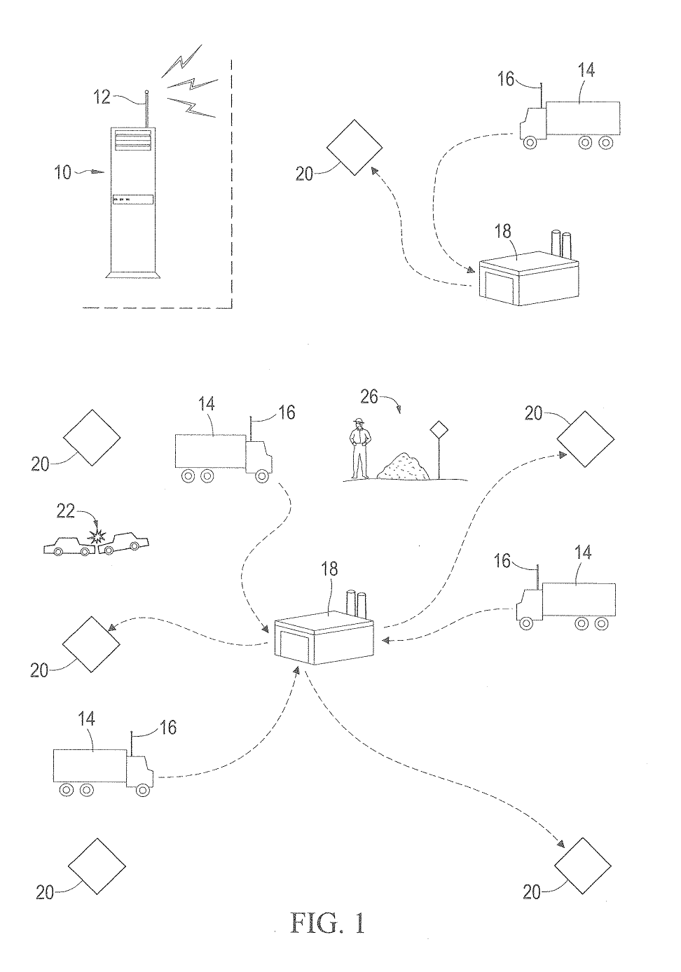

FIG. 1 depicts a map showing one embodiment of a system for dispatching multiple delivery units to load sites and delivery sites. On this map, delivery units 14 are scattered about an area, which may be a city, county, or other region with various load sites 18 and delivery sites 20. The location of at least one delivery unit 14 is transmitted via unit transceiver 16 to the server transceiver 12 and entered into the database 40 stored by at least one server 10, which may be operated by the operator or in the “cloud.” The server 10 may, but need not be, located in the same general area or region as some or all load sites 18 and/or delivery sites 20. The unit transceiver 16 may be configured to communicate with the server transceiver 12 by any of various forms of wireless communication, such as an electronic transceiver, a GPS device configured for two-way communication, or a wireless phone, and the server transceiver 12 is any communication device capable of receiving a signal from the unit transceivers 14. By way of example, the unit transceiver 16 may be configured to automatically transmit to the server transceiver 12 periodically, or the unit transceiver 16 may be in constant communication with the server transceiver 12. Alternatively, the driver of the delivery unit 14 may manually submit its location via a wireless phone, such as by calling the location into a dispatch operator who then enters the location into the server 10. In this instance, the driver's wireless phone is the unit transceiver 16, and the dispatch's communications device is the server transceiver 12. A person of ordinary skill in the art would be aware of other devices and methods for communicating the location of the delivery unit 14 to the server 10.

Because the server 10 receives updates as to the location of numerous delivery units 14, the actual starting location for any particular delivery unit 14 can change each time the server prepares a new set of transport itineraries. The server 10 and the process used to prepare new transport itineraries are further discussed below.

If desired, each delivery unit 14 may also have particular cost or time characteristics associated with it. For example, the driver of the delivery unit 14 may have a higher or lower salary than other drivers, or be governed by specific labor rules. Drivers may also be subject to workday constraints, such as the number of consecutive hours the driver can be on the job, or restrictions on which load sites 18 they can load from. In addition, the delivery unit 14 itself may have distinguishing information, such as associated maintenance costs or gas mileage rates that vary according to each delivery unit 14. This information, and information regarding other costs or constraints, is stored in the database 40 and may be used to determine the transport itineraries according to the constraint factors selected by the operator.

FIG. 1 also depicts various load sites 18 and delivery sites 20 scattered across a region. A load site 18 is any location at which a delivery unit 14 may take on a load of pre-mixed concrete, such as a concrete mixing plant. In any given region, there may be multiple load sites 18 scattered about where a delivery unit 14 may take on a load. Each load site 18 may have characteristics particular to that load site 18. For example, one load site 18 may go offline for maintenance or other reasons at particular times and therefore be unavailable for providing loads. Also, due to differences in plant construction and equipment, each load site 18 may have different time rates for loading delivery units 14. Furthermore, if the load sites 18 receive their raw materials from different suppliers, then load sites 18 may have different prices at which they sell the loads, or there may be other cost factors. Also, load sites 18 may only be able to mix limited types of pre-mixed concrete, such that not all load sites 18 in an area may be used to prepare particular compositions or mixes of pre-mixed concrete. These various types of information, and other relevant information, may be stored by the server 10 or updated as necessary and may be used to prepare transport itineraries according to various scheduling constraints.

A delivery site 20 is any location that is scheduled on a given day for delivery of a load of pre-mixed concrete being managed by the system. Construction crews contract with the concrete supplier to supply an estimated amount of the desired type of pre-mixed concrete on particular days at particular locations. These delivery sites are provided to the server 10 with their locations and any other information that may be relevant to determining the transport itineraries. For example, a particular delivery site 20 may have the capacity to have two (or more) delivery units 14 delivering loads simultaneously. On the other hand a delivery site 20 may have particular issues with access that make delivery of a load take longer than usual; this additional estimated time for delivery can be included in the server database 40. Furthermore, different delivery sites 20 will require various amounts of concrete, in which case multiple delivery units 14 may be needed to fulfill the total order. Finally, according to the contract between the concrete supplier and the construction crew placing the order, a particular delivery site 20 may be subject to a late delivery penalty which increases proportionally to how late a load of concrete is delivered. This data and other relevant information may all be stored in the database 40 for use in preparing the transport itineraries.

In addition to storing fixed information or receiving updated real-time information related to the delivery units 14, the load sites 18, and the delivery sites 20, the server 10 may also store or receive other information that may be considered relevant to preparing transport itineraries. For example, the server 10 may receive real-time updates concerning traffic information, such as slow traffic due to a traffic wreck 22 or road construction and maintenance 24. Other relevant information may include fixed costs to open a plant, weather information and local gas or diesel prices. FIG. 3 depicts a schematic showing the database 40 with subsets related to fixed or occasionally variable information 42, real-time traffic and other general information 44, real-time delivery unit information 46, load site information 48, and delivery site information 50.

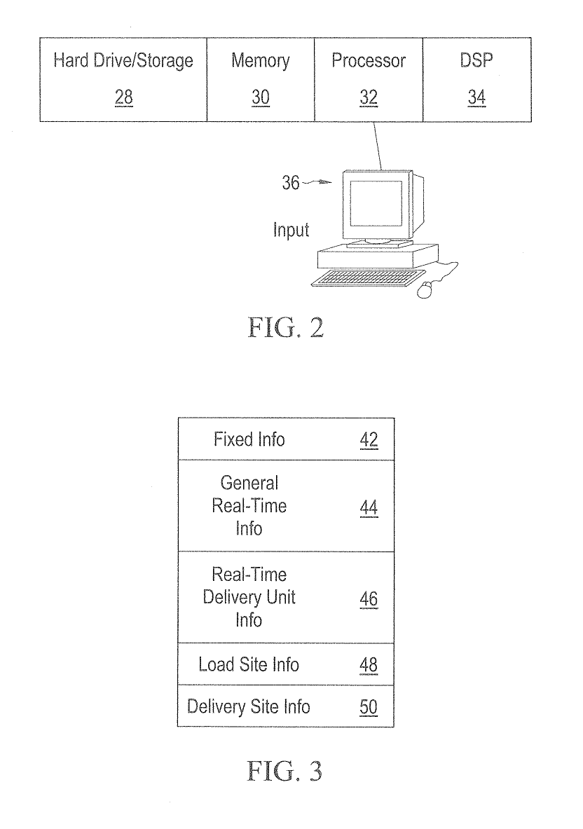

The server 10 determines the transport itineraries according to the information stored or received into the database 40 and according to one or more operator-provided scheduling constraints. FIG. 2 depicts exemplary hardware for the server 10 to receive and store information, process and prepare the transport itineraries, and transmit the schedules to the delivery units 14. First, the server 10 has memory 30 for accessing and manipulating data stored in the database 40. The database 40 may be stored in a local storage disk 38, or alternatively may be stored on a remote server to which the server 10 is connected, either through a LAN or the Internet. The server 10 also has at least one data input method. For data submitted real-time from a unit transceiver 16, the data may be received wirelessly through the server transceiver 12 or otherwise relayed to the database 40. Such real-time data is processed by the processor 32 and then stored in the database 40. Other information may be input manually by the operator through any of various forms of manual input 36, such as a personal computer having a mouse and keyboard, direct upload from a CD, DVD, or flash drive, or otherwise manually downloaded by the server 10.

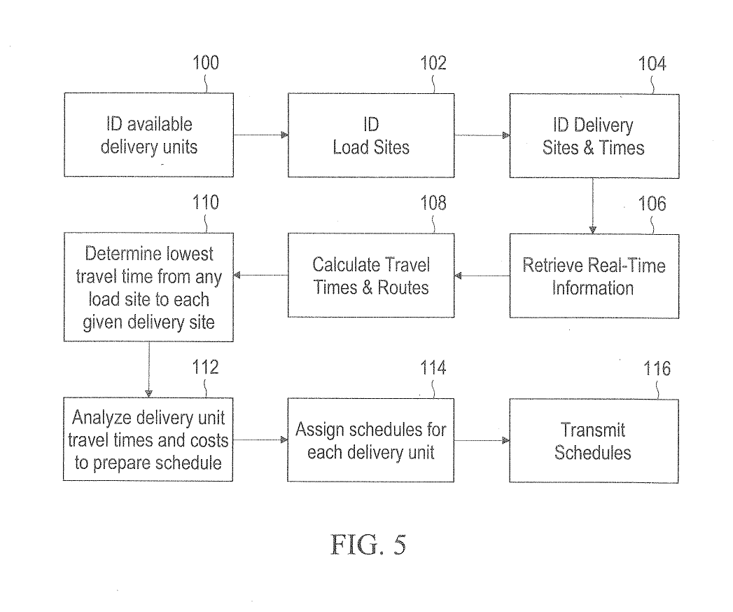

When the operator requests preparation of new transport itineraries, the server processor 32 runs the scheduling algorithms further described herein with reference to FIG. 5 in order to produce a transport itinerary for the selected delivery units 14. Once the transport itineraries are prepared, they are transmitted through the server transceiver 12 to the designated delivery units 14. Persons having ordinary skill in the art will understand that any known or novel configuration for transmitting digital signals from the processor 32 to the server transceiver 12 may be used.

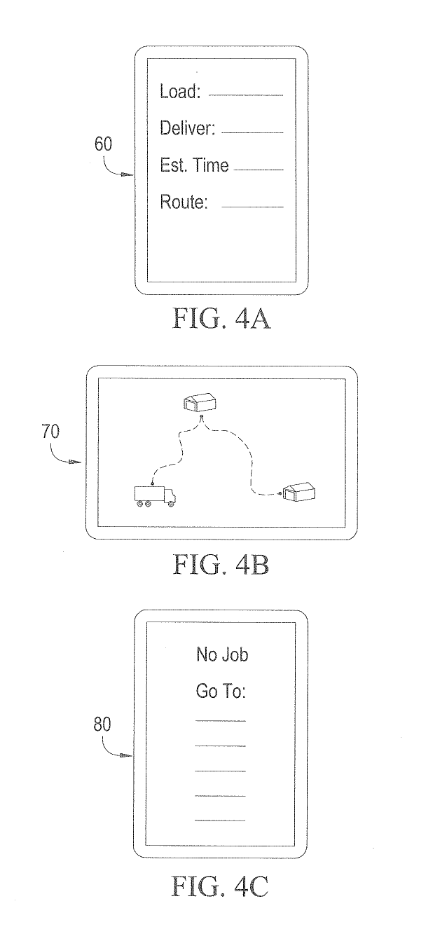

FIGS. 4a, 4b, and 4c depict a few alternative methods of outputting the transport itineraries to the delivery units 14. In FIG. 4a, the transport itinerary is depicted in a written display 60 identifying one or more delivery sites 20 and the respective load sites 18 at which the loads will be taken on. Furthermore, the driver of the delivery unit 12 may also receive a particular route 62 and estimated time 64. The display 60 is received via the unit transceiver 16 and displayed by any device capable of displaying the information. For example, the unit transceiver 16 itself may have the capability of depicting the display 60 to the driver, or alternatively, the unit transceiver 16 may be connected to another device for viewing by the driver.

In FIG. 4b, the transport itinerary is provided on a graphic display 70, such as a GPS device or smart phone having GPS capability. In this embodiment, the unit transceiver 16 receives the transport itinerary and communicates it to a device having graphic display or GPS capabilities, so that the driver of the delivery unit 14 can follow the route provided.

As depicted in FIG. 4c, if the server 10 determines in preparing the transport itinerary that not all delivery units 14 are needed to deliver the remaining outstanding loads for the day, the server may instead transmit a “Finished” message 80 to the delivery units 14 that are not selected for delivering loads. Optionally, the server 10 may also direct the delivery unit 14 to a particular location for maintenance, parking, or other matters.

FIG. 5 depicts a process flow chart for preparing and transmitting the transport itineraries for a plurality of delivery units 14 taking on loads of pre-mixed concrete from a plurality of load sites 18 and delivering them to a plurality of delivery sites 20. First in 100, a subset of the delivery units 14 are identified as being available to deliver a load to at least one delivery site 20. When the process is conducted prior to the beginning of the day's deliveries, all delivery units 14 in the plurality of delivery units 14 will likely be available, unless some delivery units 14 are removed from work for the day due to insufficient numbers of drivers, maintenance, or some other cause unrelated to being committed to a delivery. However, as the transport itineraries are updated, revised, or modified throughout the day, several delivery units 14 will be committed to delivering loads and therefore may be unavailable for scheduling another load at the time the scheduling process is being conducted. In some embodiments, if the estimated time for a delivery unit 14 already committed to one or more deliveries exceeds a limit during which the scheduling process intends to schedule future loads, that delivery unit 14 may be excluded from the subset of delivery units 14 receiving a new transport itinerary. For example, if the scheduling process is assigning deliveries for the ensuing hour, and a delivery unit 14 is estimated to be committed to a prior-scheduled delivery for the next two hours, that delivery unit 14 will not be considered “available” and will be excluded from the subset. In other embodiments, all delivery units 14 may be included in the optimization process, but the processor 32 may assign estimated times for which a delivery unit 14 that is precommitted to prior assigned deliveries cannot be used to deliver a new load. For example, if a delivery unit 14 is already assigned to deliver a load to a particular delivery site 20, and that delivery is scheduled to last an additional 45 minutes, that 45 minute period would be added to any delivery time schedule developed for that particular delivery unit 14.

Next in 102 and 104, load sites 18 and delivery sites 20 are identified for conducting the scheduling process. The available load sites 18 and scheduled delivery sites 20 are often known at the beginning of the day. However, as new sets of transport itineraries are prepared throughout the day, the available load sites 18 and delivery sites 20 may be updated to reflect new circumstances that impact scheduling. For example, a load site 18 may shut down during the day, either for routine or unexpected reasons. Alternatively, a rush job to a new delivery site 20 may be added. Furthermore, as deliveries to particular delivery sites 20 are completed, those delivery sites 20 will be removed from the scheduling process. Accordingly, as the day proceeds, each recurring scheduling run will identify the current available load sites 18 and delivery sites 20, along with the scheduled times for delivery at the delivery sites 20.

Also, in 106, real-time information concerning the delivery units 14, the load sites 18, the delivery sites 20, traffic, and any other relevant general information is received by the server 10. Real-time information may be gathered before or after identifying the various delivery units 14, load sites 18, or delivery sites 20.

Then in 108, the processor 32 will use the real-time information and fixed information to calculate estimated travel times from the selected delivery units 14 to each load site 18 and then each delivery site 20. For example, in a scheduling run wherein three load sites 18 and six delivery sites 20 are identified, each available delivery unit 14 will have eighteen possible routes. The calculated routes will have associated costs, distances, and time estimates related to the real-time and fixed information sets regarding delivery units 14, load sites 18, delivery sites 20, and traffic and other relevant information.

Because pre-mixed concrete is perishable, each batch of concrete has a perishability time limit, which may be determined according to the mix and batch characteristics of the concrete. Concrete which would be delivered after the perishability time limit becomes unusable. Therefore, the processor determines any combinations of load site, delivery site, and delivery unit that would result in the travel time for the concrete exceeding the perishability time limit for that concrete load. The processor should then disregard any combinations of sites and units that result in a load exceeding the perishability time limit. This may be achieved, for instance, by removing any such combination from consideration, by assigning an infinite cost value to any loads delivered according to such combination, or any other manner for effectively preventing a combination resulting in exceeding the perishability time limit from being scheduled.

Next in 110, the processor determines the total number of expected deliveries for the entire day and the desired blend or composition of concrete at each delivery site 20 in order to create a list of load sites 18 from the load sites 18 identified in 102 that are capable of producing the desired blends of pre-mixed concrete. From this list the processor 32 selects the expected load site 18 having the necessary capabilities to produce the desired blends that is closest to the delivery site 20 (based on either the travel times or the distances determined in 108, as the operator may select or as may be preconfigured for the processor 32). Based on prevailing travel times to the delivery site 20 and the expected time for the arrival for the delivery, the processor 32 calculates the necessary time of departure from the expected load site 18 for a delivery unit 14 to deliver a load on time for each delivery. After the processor 32 completes this calculation for every delivery, the processor 32 will create a list of deliveries correlated with each expected load site 18, sorted according to their calculated load site departure time.

in 112, the processor 32 analyzes the list sorted by departure time created in 110 to create a schedule of deliveries with a lower overall cost. First, the processor 112 determines the next N scheduled deliveries during the day. The number “N” is the number of deliveries into the future that will be scheduled. A small “N” will result in fewer deliveries being scheduled during a particular use of the process. A larger “N” will allow more deliveries to be scheduled but will require more processing power and time. In some embodiments, “N” is preset in the initial configuration. In other embodiments, “N” is entered by the operator, based on the desired speed of the calculation and the time period desired to determine for scheduling the deliveries.

In this set of “N” deliveries determined in 112, the first in the set, which is the most urgent delivery, is evaluated using all potential delivery units 14 and all potential load sites 18 to determine a cost of delivery for each combination. Depending on the desired concrete blends and the capabilities of each load site 18, not all load sites 18 may be evaluated for each delivery unit 14. The cost of delivery is calculated using a number of factors, including the real-time information concerning the delivery units 14, the load sites 18, the delivery sites 20, prevailing traffic conditions received by the server 10, a weighted cost for any lateness in delivery, and fixed costs or assumptions included in the database 40. If the expected time between when the concrete for a particular load is mixed at the load site 18 and when it can be unloaded at the delivery site 20 exceeds the allowed age for the load, the processor 32 will assign an infinite or prohibitive cost to that combination of delivery unit 14 and load site 18. This prevents the system from assigning loads to delivery units 14 that are completely unsuitable for delivering a load due to the amount of time required for the delivery to occur and the resulting lost concrete. The result of this computation is a two dimensional matrix representing the computed cost of delivery for each combination of delivery unit 14 and load site 18 for the first delivery contained in set “N,” known as a unit-versus-load matrix of costs for each delivery. This computation and subsequent creation of a resulting unit-versus-load matrix of costs for each delivery is repeated for each and every delivery contained in set “N.” Next the processor 32 evaluates each unit-versus load matrix to determine the least expensive load site 18 for each delivery unit 14, in order to find the least expensive load site 18. The result is a column of lowest cost values associated with each delivery unit 14 for a given delivery, known as a unit-cost-per-delivery vector. As each delivery is evaluated to produce a similar unit-cost-per delivery vector, the vectors are arranged into a resulting two-dimensional matrix, which represents the least expensive cost values for each delivery unit 14 to make each delivery. This is known as the unit-cost-per-delivery matrix.

The processor 32 then evaluates the unit-cost-per-delivery matrix to produce a delivery schedule reflecting the best overall combination of delivery unit 14 and load site 18 for a given delivery site 20. The linear assignment algorithm selected to evaluate the unit-cost-per-delivery matrix may depend on the operator's desired speed and exactness of the final solution. In some embodiments the linear assignment algorithm commonly referred to as the primal dual algorithm is used, but other commonly known linear assignment algorithms may be used as well. The result of any of these will produce a delivery schedule that reflects the best overall combination of delivery unit 14 and load site 18 for a given delivery.

Upon conclusion of the analysis, in 114 the selected transport itineraries are assigned to the designated delivery units 14 based on the two-dimensional matrix produced in 112. Each transport itinerary has at least one delivery site 20 to which the delivery unit 14 will deliver a load. The load will be picked up from the load site 18 that is also identified on the transport itinerary. The transport itinerary will also include a preferred route, which has been determined according to the real-time conditions received by the server 10. If there are more available delivery units 14 than there are deliveries to be made, not every delivery unit 14 will be assigned a transport itinerary.

In 116, the server 10 transmits the transport itineraries to the selected delivery units 14 through the server transceiver 12. Optionally, in 118, the server also alerts any available delivery unit 14 to which a transport itinerary was not assigned that there are no more deliveries to be made at that time.

At the beginning of each day, or the night before, a preliminary delivery schedule is created using the scheduled delivery times at the delivery sites 20 and historic data concerning traffic, delivery units 14, and load sites 18. After the preliminary schedules are created, drivers are assigned to delivery units 14 to make the initial deliveries. Prior to or during the loading of the delivery units 14, traffic and other real-time conditions may be received by the server, and the process can be completed again to adjust travel times according to changes in the traffic conditions observed in real time. For example, a driver of a delivery unit 14 may call in a wreck at a given location, which may affect his delivery or the deliveries made by other delivery units 14. Other possible sources for recalculating the transport itineraries may include without limitation alerts from news organizations, service providers, or other sources, police radio monitors, or real-time traffic monitors.

While it is possible to run a complete scheduling process and produce transport itineraries for some or all delivery units 14 to fill the entire day, it is not recommended that this process be used to complete an entire day's schedule in a single run. First, completing the scheduling process requires significant processing power. Second new real-time information may significantly alter the most desirable scheduling system. If, for example, a traffic accident in the late morning completely shuts down a main thoroughfare that the scheduling process had assumed would be an open and efficient route, based on historic information concerning the traffic congestion on that road, the entire schedule for all delivery units 14 may become inaccurate and result in significant time delays and cost expenses. Rather, because the scheduling process disclosed herein both takes into account real-time data and can be utilized regardless of the starting location or availability of any particular delivery unit 14 at a given time, the process can be used to schedule shorter periods of time, or time windows, and run multiple times each day. For example, in one embodiment of the process, transport itineraries are prepared only for deliveries that are scheduled within the next two hours after completing the scheduling process. The length of time chosen may vary according to the complexity of the system being managed, the number of deliveries made in a period, the rapidity of changes and updates in real-time information, and other factors. With reference to 112, this will result in a subset of N deliveries being analyzed at any given time, rather than the entire set of scheduled deliveries remaining for the day. By running the scheduling process multiple times a day, the scheduling system is also more responsive to unforeseen changes in traffic conditions, delivery units 14, load sites 18, and delivery sites 20.

In another embodiment of the process, rather than selecting only those delivery units 14 that are expected to come available during the time window the process is scheduling for, the process will identify all delivery units in the system, regardless of their status for delivering loads. In this embodiment of the process, after calculating the updated route times for the selected delivery units 14, the delivery units 14 may be assigned revised transport itineraries that modify their prior scheduled route. For example, if one delivery unit 14 becomes caught in a traffic jam, must take an alternative route, or for some other reason is unable make its expected delivery on time, another delivery unit 14 may be assigned to take on a load at a load site 18 and deployed to cover the delivery from the original delivery unit 14 that is missed or delayed, particularly if the cost of load is calculated to be less than the cost or penalties for late delivery. By efficiently rerouting delivery units 14 that are traveling to other delivery sites 20, the scheduling process can save time and costs related to late deliveries. Further advantages includes allowing the concrete company to alert the delivery site 20 regarding the revised time schedule and then warn and re-route delivery units 14 of possible delays as necessary.

### Illustrative Embodiment

In order to illustrate the general principles set forth, a simple example of the actions performed by the processor 32 is included herein for a set of four delivery units 14 (U1, U2, U3, U4), four delivery sites 20 each receiving a single load of concrete (D1, D2, D3, and D4), and two load sites 18 (L1, L2). This example is intended for illustrative purposes only and does not otherwise limit the scope of disclosure.

In 100, the processor 32 identifies delivery units U1, U2, U3, and U4 as available to make the four deliveries to be scheduled. In 102, the processor 32 identifies load sites L1 and L2 as available to load any of the deliveries to be made. In 104, the processor 32 identifies the delivery sites D1, D2, D3, and D4 associated with the four scheduled deliveries. In 106, the processor 32 receives real-time information related to the location and status of the delivery units U1, U2, U3, and U4, traffic information, and other real-time information used to create a cost estimate for the delivery.

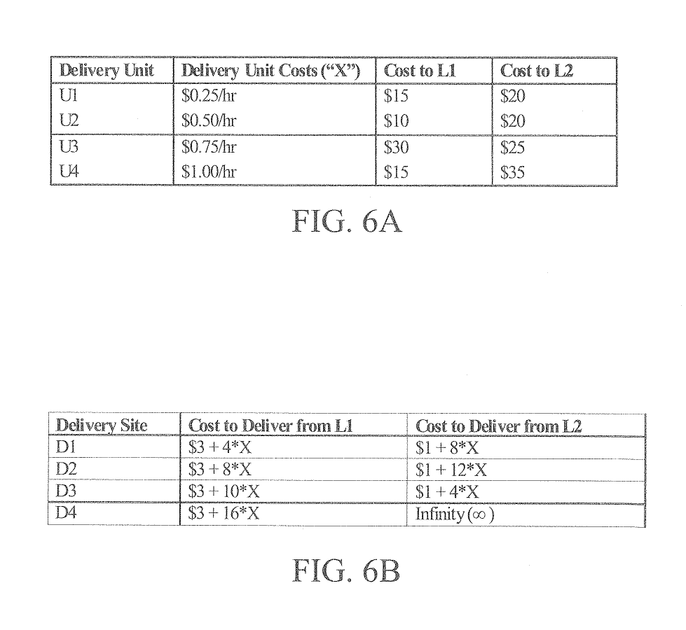

In 108, the processor 32 calculates the travel times and associates costs and routes for each delivery unit 32 to the load sites 18 and delivery sites 20. For this example, the table set forth in FIG. 6A identifies the cost for the selected delivery units 14 to travel to each load site 18 and the total hourly cost associated with the delivery units 14 (which is determined from factors such as driver salary, gas, delivery unit maintenance, and other relevant factors). The table set forth in FIG. 6B identifies a possible equation for determining the cost of delivering a load of concrete from either load site 18 to each delivery site 20. The equation shown is simplified for illustrative purposes to include a constant for fixed costs, such as the cost of concrete purchased from the load site 18, and variable costs, which in this example is based on the hourly cost rate associated with each delivery unit 14. In actual practice, the calculation or equations relied upon may be much more complex than the illustrative example provided here.

In this example, as shown in FIG. 6B, any delivery made from L2 to D4 would exceed the perishability time limit for the concrete, which would result in the loss of the entire load. Therefore, an infinite value is assigned to deliver loads from L2 to D4 in order to effectively remove consideration of that load site-delivery site combination when determining the route and delivery schedule.

In 110, the processor 32 determines the order of deliveries based on the departure time from the load site and orders them into a list or column. In this case, the deliveries are listed as [D1, D2, D3, D4].

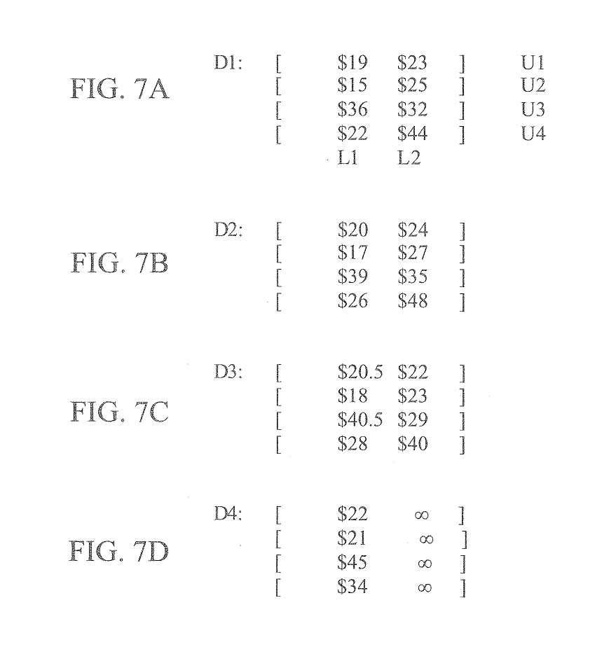

In 112, the processor analyzes each delivery in the list to determine the lowest overall costs. First, the processor 32 calculates a unit-versus-load matrix of cost for each delivery, using the costs identified in 108. In this example, those costs are set forth in FIGS. 6A and 6B and are calculated by adding the cost of each delivery unit 14 to reach each possible load site 18 in FIG. 6A, and then adding the cost determined by the equation in FIG. 6B for that delivery unit 14 to deliver to the delivery site 20 for that delivery. The unit-versus-load matrix of costs for each delivery are set forth as FIGS. 7A, 7B, 7C, and 7D. In FIG. 7D, the second column of the matrix has infinite values because the delivery time for any unit to travel L2 to D4 would exceed the perishability time limit for that load.

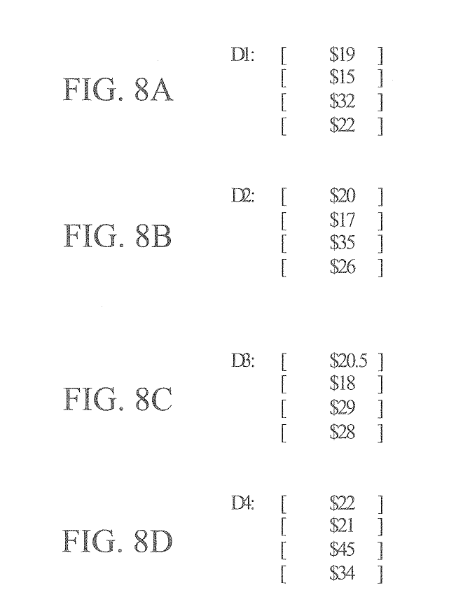

After calculating the unit-versus-load matrices of costs for each delivery, the processor 32 evaluates the matrices to determine the least expensive load site 18 for the selected delivery unit 14 to make each delivery being scheduled, to determine the unit-cost-per-delivery vector for each delivery. For this example, the vectors are set forth in FIGS. 8A, 8B, 8C, and 8D.

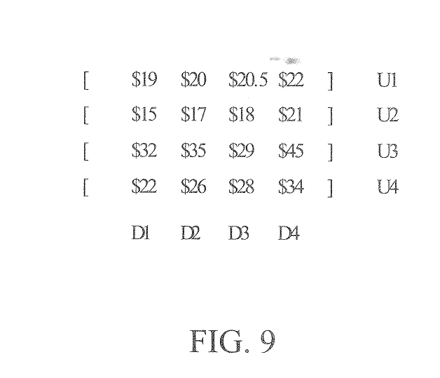

The processor 32 arranges these vectors into the unit-cost-per-delivery matrix, which represents the lowest cost for the selected delivery unit 14 to deliver concrete to each delivery site 20. Each row in the matrix is associated with a particular delivery unit 14, and each column is associated with a particular delivery. For this example, the unit-cost-per-delivery matrix is set forth in FIG. 9.

The processor 32 next conducts a linear assignment algorithm, such as the Hungarian algorithm, primal dual algorithms, or the simplex algorithm, to determine the optimal assignment of delivery units 14 to the deliveries associated with the delivery sites 20. In this example, the lowest cost for the four deliveries to be made is $90, which may be achieved as follows: U1 delivers to D4, U2 delivers to D2, U3 delivers to D3, and U4 delivers to D1.

In 114, these assignments are correlated with the appropriate load sites to establish and assign a transport itinerary for the selected delivery unit 14. In this case, the transport itinerary is as follows: U1 receives a load from L1 and delivers to D4; U2 receives a load from L1 and delivers to D2; U3 receives a load from L2 and delivers to D3; and U4 receives a load from L1 and delivers to U4. These load site assignments are identified as the least-cost load site in the unit-versus-load matrix of costs.

In 116, the server 10 transmits the transport itineraries determined by the processor 32 to the delivery units 14. The delivery units 14 proceed according to the schedule determined.

### Embodiments having Other Timing Elements

The above illustrative embodiment considers scheduling concrete delivery units 14 in view of real-time information gathered from delivery units 14 and other sources. Information concerning the timing of delivery units 14 may also be provided by input from the driver, which allows the itineraries to be modified on the basis of delays at loading, pouring or post-pouring events. The inclusion of these types of events, which are often within the control of the driver, also can permit the driver to receive feedback concerning the driver's performance as well as allow the scheduling server 10 to modify the scheduled routes or deliveries.

In the delivery cycle for concrete, the steps that are typically most easily influenced by the driver include the time between “Clock In” and “In Service;” the time between “End of Loading” and “To Job;” the time between “On Job” and “Unloading;” the time between “End Washing” and “To Plant;” and the time between “At Plant” and Clock Out.” “Clock In” refers to the time at which a driver arrives at the plant and clocks in, or otherwise marks his arrival at the plant to begin work for the day. “In Service” is the time at which the driver arrives at the assigned delivery unit 14 and is ready to begin loading concrete. “End of Loading” is the point in time after completion of loading the delivery unit 14 with concrete. “To Job” refers to the time at which the driver departs the plant to travel to the job location. “On Job” refers to the time at which a driver arrives at the job location. “Unloading” is when the driver begins actually pouring the concrete at the job location. After the pour is completed, the delivery unit 14 must be washed out. “End Washing” refers to the time when washing is completed and the driver can depart to return to the plant. “At Plant” is the time the driver arrives at the plant and either prepares to begin another job (at which point the delivery unit 14 is loaded and the cycle can revert back to “End of Loading”) or prepares to end the day. If the day is ended, “Clock Out” refers to the point when the driver officially clocks out or otherwise marks his departure from the plant at the end of the day.

To receive input from the driver, the display 60 of the delivery unit 14 is equipped to receive input, such as from a keypad or touch-sensing screen. In some embodiments, the display 60 is configured to provide the driver a number of different types of information, such as a timer 66 for various actions or processes, a route 62 providing a job location, driving routes or instructions, an estimated time 64 indicating whether the driver is on time or not, or other information relevant to the delivery of the concrete. The display 60 is coupled to or connected with the transceiver 16. At the beginning of a delivery cycle, the dispatch server 10 transmits via a wireless link some or all of the types of information listed above. This may further include the expected time duration for each of the steps for the delivery unit 14 making a delivery of concrete and the locations of both the loading plant and the delivery site. The driver can input information into the display 60 to indicate, when appropriate, his current status in the delivery cycle and to update, modify, or provide feedback to the central dispatcher.

Once a current status has been determined, the display 60 may show time information to the driver, such as the expected time duration for a particular action, the time elapsed since beginning the action, the time allowed to complete the action, or other time-sensitive information. Additionally, the display 60 may depict a countdown timer 66 reflecting how much time remains to complete the step in the delivery cycle. In some embodiments, as the time shown by the countdown timer 66 decreases, the color display may adjust its presentation to alert the driver of an impending deadline. For example, the display 60 may begin with the color green when a task begins. As time to the deadline nears, the color may switch to yellow. Finally, when the deadline has passed, the color may turn red, warning the driver that time has elapsed. Other alerts, such as sounds or alarms, may be used as well. This provides the driver a real-time indication of performance relative to the delivery schedule.

In some embodiments, the display 60 will show a screen or interactive indicator allowing the driver to review the measured time against the expected or scheduled value. Additionally, a driver may be asked to accept, adjust, or explain a particular time entry. The driver may do so by using the provided input device. The driver may also supply additional information relevant to the time expended in that step. For example, in some cases, and as described more particularly below, a driver may not be responsible for the delay. Instead the delay may have been caused by problems at the customer's site, poor traffic, weather delays, poorly maintained delivery units 14, or issues at the plant. In other cases the driver's actions may be the cause of a delay. The driver may adjust and explain the cause of the delay in real time by entering the cause on the input device. This information is then transmitted wirelessly back to the dispatch server 10 for long term storage and reporting. The feedback is also useful for dispatchers in making adjustments in their overall delivery schedules, along with wirelessly providing drivers with real time updates on their individual delivery schedules. This process of feedback and response provides the driver a clear indication of performance according to delivery schedule. It also gives the driver a chance to supply mitigating information when the schedule is not met. Accordingly the driver may operate with a clear vision of what is expected, and can respond in real time to provide relevant supporting information. At the same time, while the dispatch server 10 can modify the schedule to delivery schedules and itineraries as needed and taking into account real-time conditions.

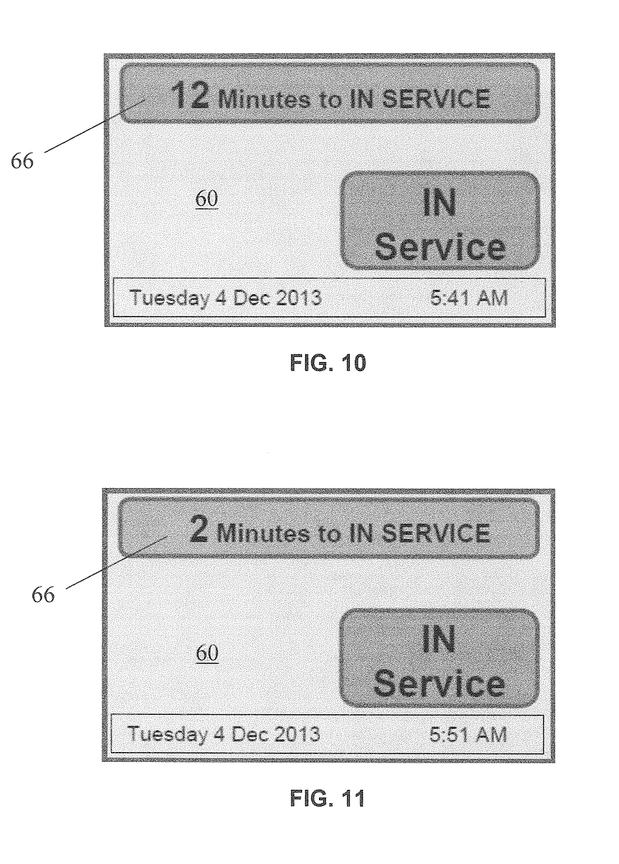

The following describes an embodiment of the generally described systems and processes set forth above. In a typical workflow for concrete delivery, the assignment begins with the driver arriving for work at a pre-assigned time and clocking-in via a timekeeping apparatus (not shown). If this apparatus is connected to the central dispatch server 10 via a network, the timekeeping apparatus may notify the computerized dispatch server 10 that the driver is onsite and readying the delivery unit 14 for making deliveries. While the driver is preparing for the first load of concrete, the dispatch server 10 may transmit to the display 60 a time 66 indicating time elapsed or time remaining until the driver and delivery unit 14 are “In Service.” The amount of time may be displayed, together with a color indicator, on the display terminal, as depicted in FIG. 10. In some embodiments, during this initial time, the color indicator may be green, or some other indicator that the driver is currently on schedule. When the driver is ready to be “In Service,” the driver provides an input to the display 60, and this is relayed to the central dispatch server 10.

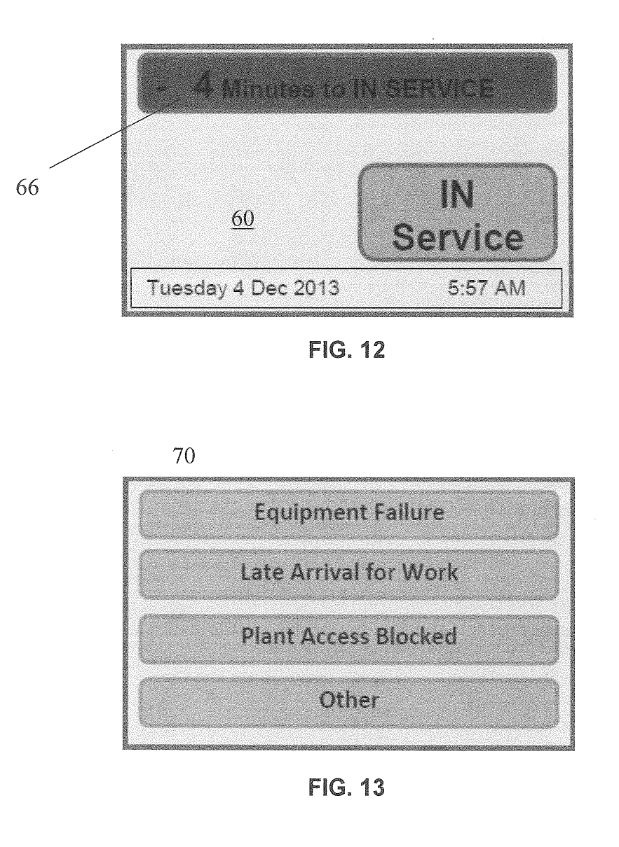

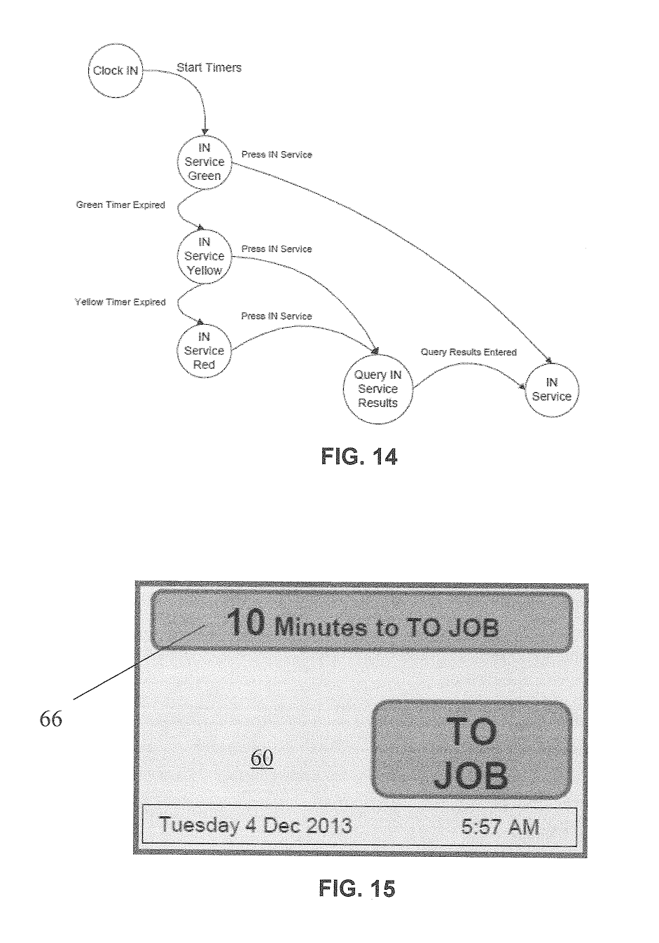

If time progresses without the driver indicating “In Service,” the timer 66 will continue to decrease. In some embodiments, when the timer 66 reaches a predetermined time approaching the deadline for going “In Service,” the display color may change to a warning indicator, such as yellow, indicating the impending expiration of allowable time, as shown in FIG. 11. If the time for going “In Service” expires, the display again changes colors, for example to red, to indicate to the driver that the allotted time for going “In Service” has elapsed, as depicted in FIG. 12. In some embodiments, when the driver has input the “In Service” indicator after time has been exceeded, the display 60 may display a query screen 70 on the display 60, asking the driver to provide a reason or explanation for the delay. Such reasons could include reasons beyond the driver's control, such as equipment failure or blocked plant access, or reasons in the driver's control, such as late arrival to the plant. A sample query screen 70 is provided in FIG. 13. A flow chart of the above-described process from the driver's “Clock In” to “In Service” indication is provided in FIG. 14.

The next step in the typical workflow begins with the driver driving his delivery unit 14 away from the concrete plant loading point after receiving a fresh load of concrete. It is typical at this point for a driver to stop before leaving the plant area entirely to rinse off the delivery unit 14 and to visually examine the load of concrete in the mixer drum. This examination is an important step because it allows for any needed corrections to be made to the concrete before departing to the delivery site. For efficiency, it is important that the driver complete the delivery unit 14 rinse and to verify the condition of the concrete in the mixer in a timely manner. There is normally a fixed amount of time that is allowed for this to occur, and this time may be wirelessly communicated to the display 60 in the delivery unit 14 at the beginning of the loading cycle. The allotted time will be shown on the in-cab display 60 along with an associated input device to indicate that the load of freshly mixed concrete is ready to leave the plant and begin the journey to the delivery site. An example of the timer 66 for this step is shown in FIG. 15.

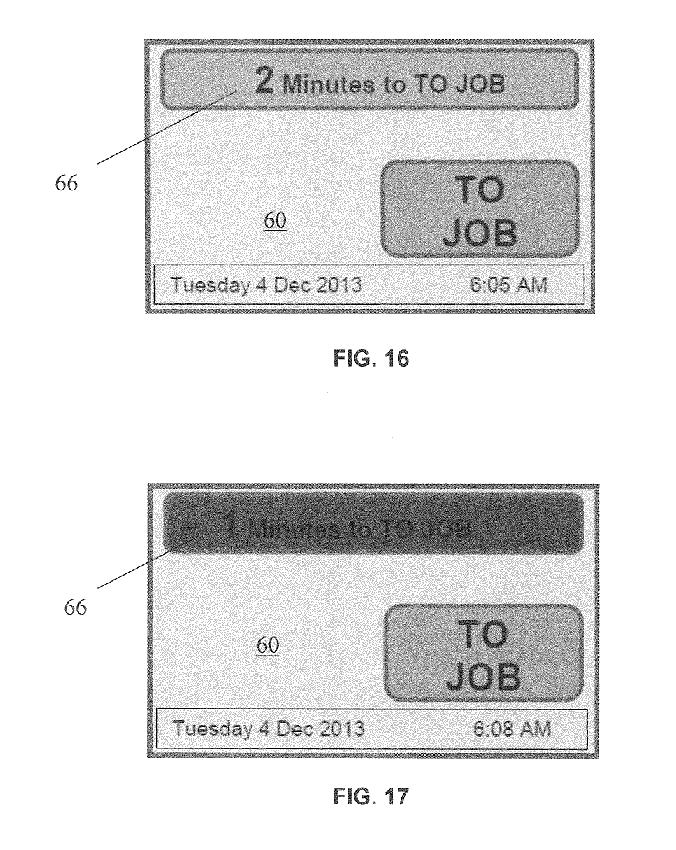

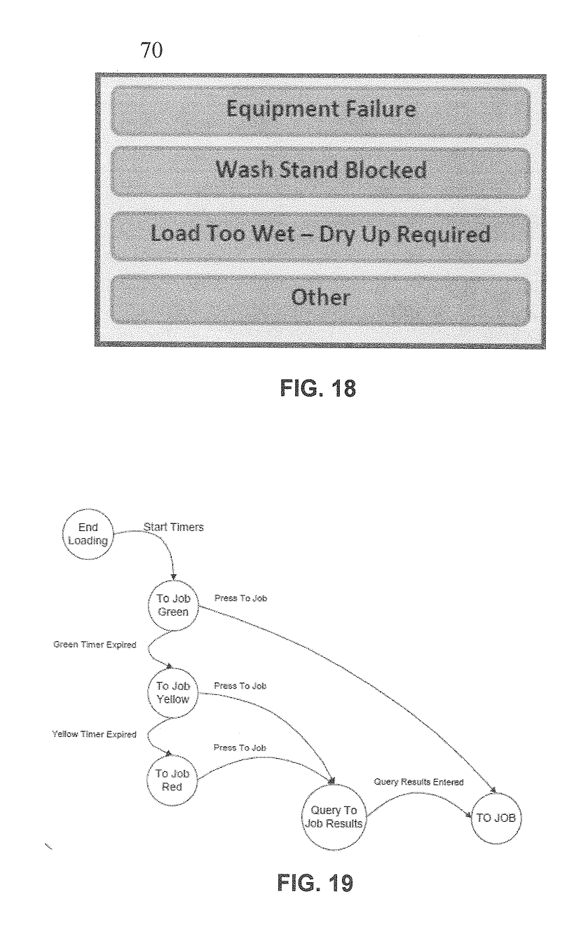

If time progresses without the driver indicating “To Job,” the timer 66 will continue to decrease. In some embodiments, when the timer 66 reaches a predetermined time approaching the deadline for going “To Job,” the display color may change to a warning indicator, such as yellow, indicating the impending expiration of allowable time, as shown in FIG. 16. If the time for going “To Job” expires, the display again changes colors, for example to red, to indicate to the driver that the allotted time for going “To Job” has elapsed, as depicted in FIG. 17. Again, in some embodiments, when the driver has input the “To Job” indicator after time has been exceeded, the display 60 may display a query screen 70 on the display 60, asking the driver to provide a reason or explanation for the delay. A sample query screen 70 is provided in FIG. 18. Another flow chart of the above-described process from the driver's “End of Loading” to “To Job” indication is provided in FIG. 19.

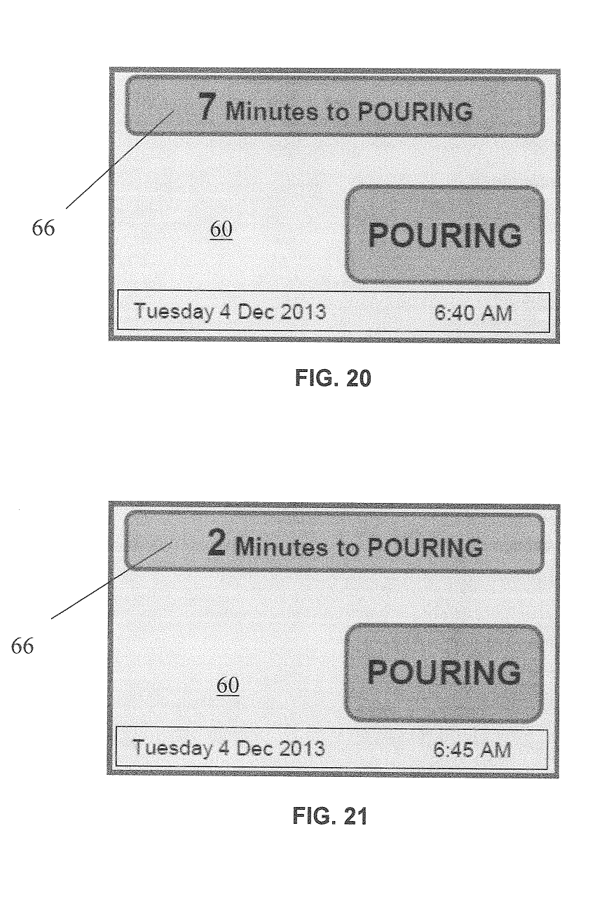

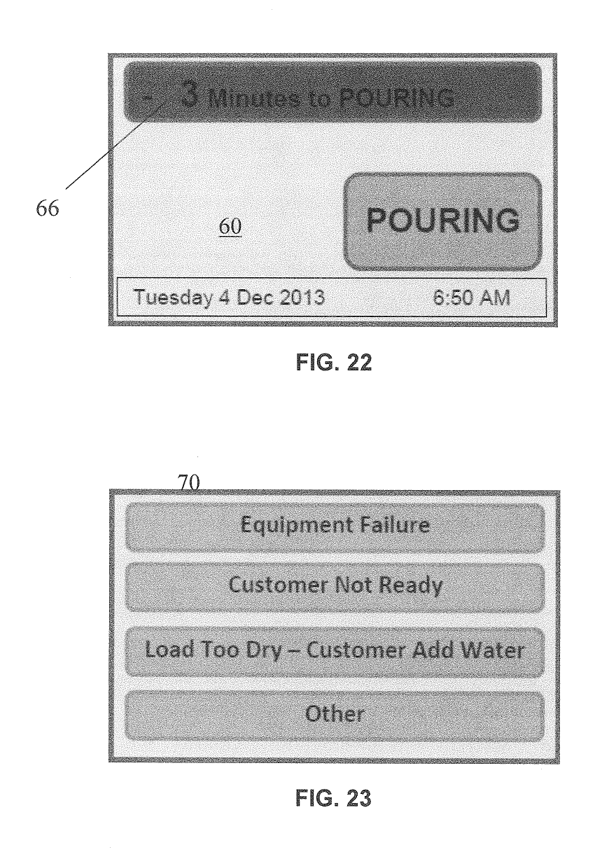

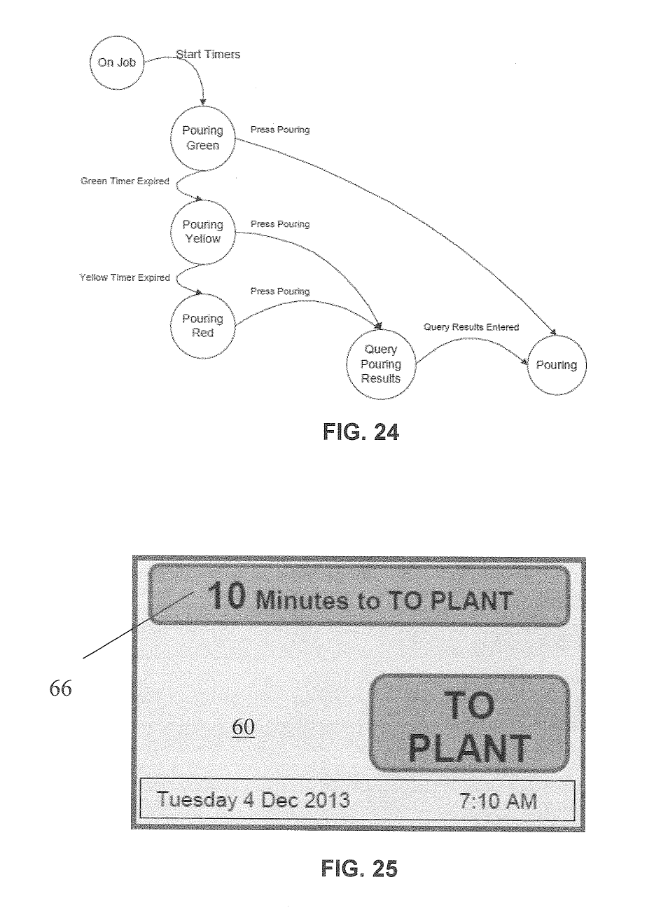

Once the driver arrives at the job site, the delivery unit 14 is positioned to unload concrete from the delivery unit 14 mixer. It is normal at this point for a driver upon arriving at the delivery site to coordinate with a delivery site foreman the desired location for the concrete. For efficiency, it is important that the driver determine the pouring location and begin the pour of the concrete from the mixer in a timely manner Again, there is normally a fixed amount of time for this to occur, which may be wirelessly communicated from the dispatch server 10 to the display 60 in the delivery unit 14 and displayed as a timer 66 on the display 60 when the unloading or pouring cycle begins An exemplary timer 66 is shown in FIG. 20. As time decreases, the timer 66 may change color indicators to indicate that the time to begin pouring is nearing, as depicted in FIG. 21. If time expires, the timer 66 again changes colors to indicate the time allotted has been exceeded, as show in FIG. 22. A query screen 70 may then be displayed to allow the driver to enter reasons for the delay, as shown in FIG. 23. A flow chart of the above-described process from the driver's arrival at the job to “Pouring” indication is provided in FIG. 24.

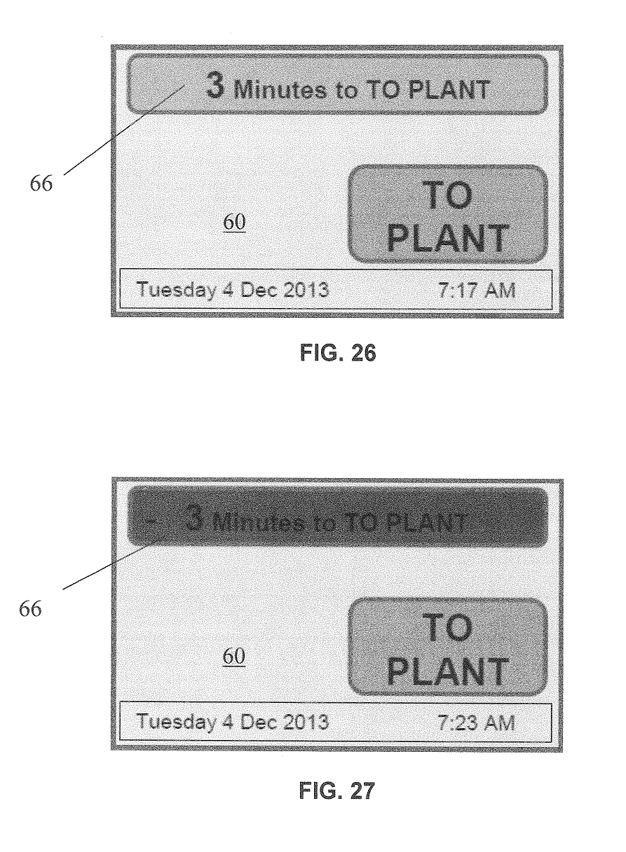

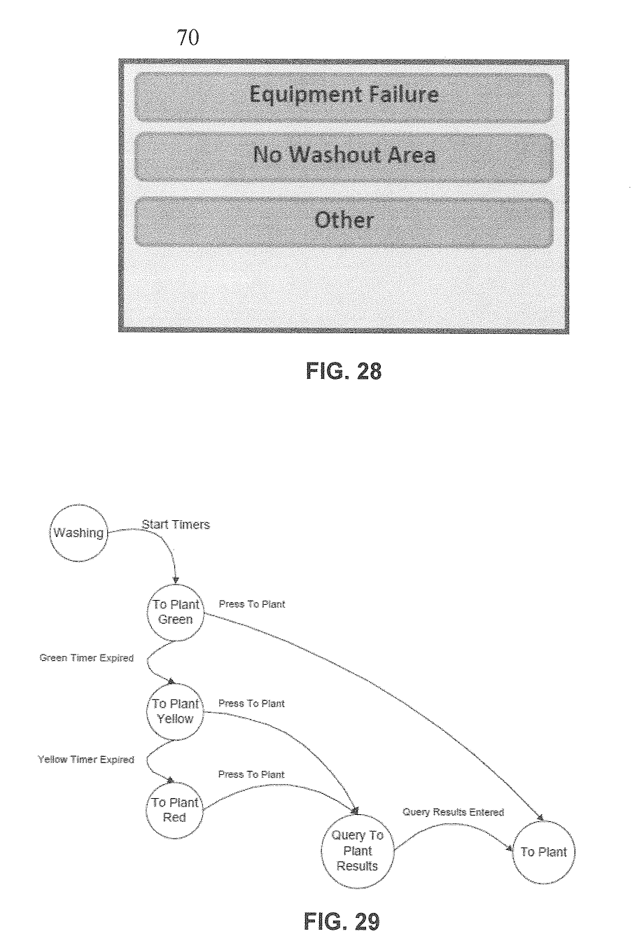

After pouring is completed, the driver prepares the delivery unit 14 to return to the production plant. It is customary for a driver to rinse and store the discharge chutes on his delivery unit 14 before leaving the job site. For efficiency, it is important that the driver complete the washing and storing step in a timely manner. Again, there is normally a fixed amount of time for this to occur, which may be wirelessly communicated from the dispatch server 10 to the display 60 in the delivery unit 14 and displayed as a timer 66 on the display 60 when the unloading or pouring cycle is completed. An exemplary timer 66 is shown in FIG. 25. As time decreases, the timer 66 may change color indicators to indicate that the time to depart for the plant is nearing, as depicted in FIG. 26. If time expires, the timer 66 again changes colors to indicate the time allotted has been exceeded, as show in FIG. 27. A query screen 70 may then be displayed to allow the driver to enter reasons for the delay, as shown in FIG. 28. A flow chart of the above-described process from the driver's end of pouring to departure to the plant is shown in FIG. 29.

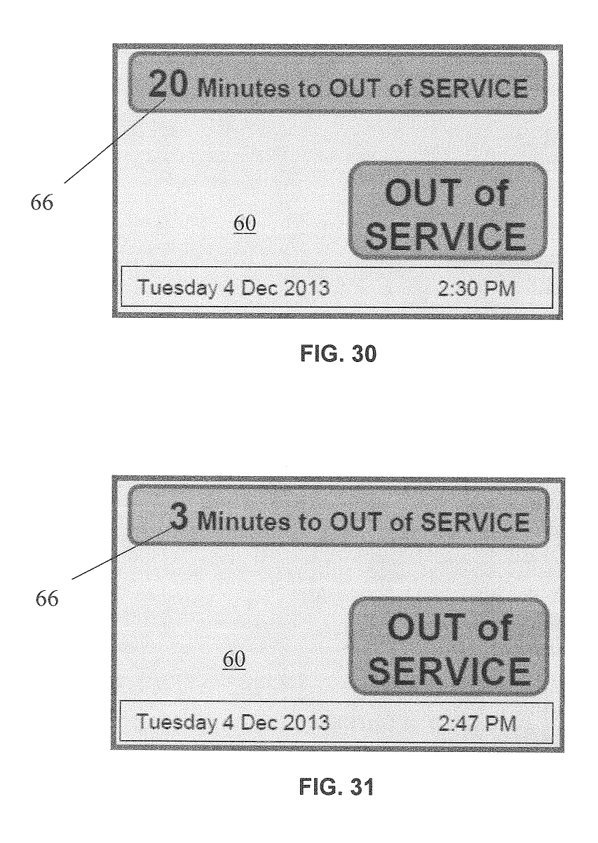

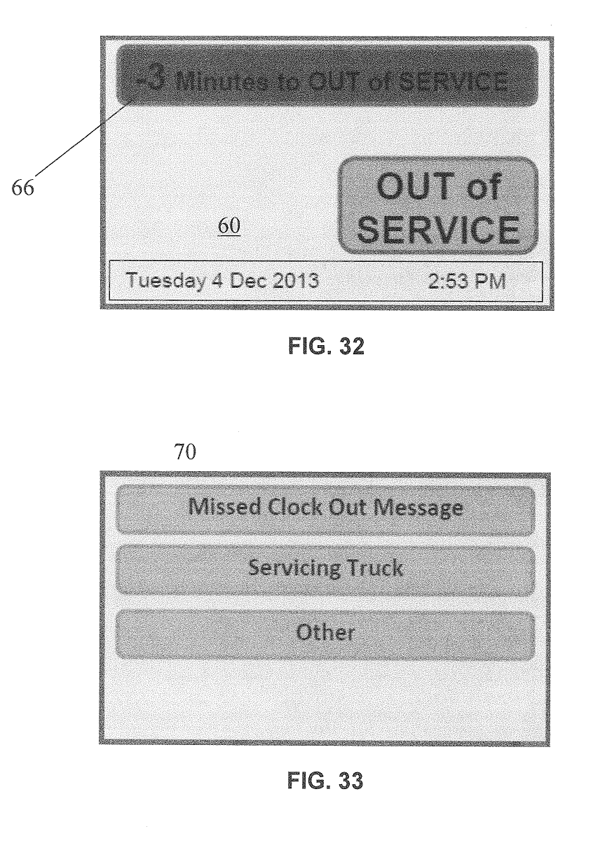

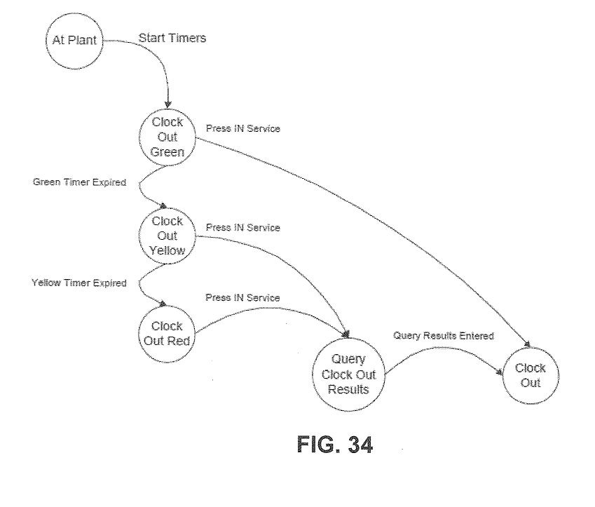

When the driver returns to the plant, additional loads may be scheduled, in which case the driver obtains a new load and performs again the sequence of events described above. After the final delivery for the day, arrives back at the production plant at the end of his workday. Typically, the driver receives a message indicating that there are no more deliveries to make, and that the driver should begin performing the end of day duties. Again, there is normally a fixed amount of time that is allowed for this to occur which may be wirelessly communicated from the dispatch server 10 to the display 60 in the delivery unit 14 and displayed as a timer 66 on the display 60 when the driver arrives at the plant at the end of the shift. An exemplary timer 66 is shown in FIG. 30. As time decreases, the timer 66 may change color indicators to indicate that the time to clock out is nearing, as depicted in FIG. 31. If time expires, the timer 66 again changes colors to indicate the time allotted has been exceeded, as show in FIG. 32. A query screen 70 may then be displayed to allow the driver to enter reasons for the delay, as shown in FIG. 33. A flow chart of the above-described process from the driver's arrival at the plant to “Clock Out” is shown in FIG. 34.

The embodiments above refer to specific steps under the driver's control. However, the timer and feedback system described herein may be used to measure other events or actions, such as travel to or from the job site. Because travel is often out of the driver's control and influenced by numerous factors such as traffic congestion, weather, accidents, and speed limits, this information would preferably not be used to grade the driver's performance. However, by providing a timer to track time, the driver and the dispatch server 10 may be alerted when the preferred delivery schedule time is not going to be met, thereby allowing the dispatch server 10 to take corrective measures, such as rerouting the driver to a different location, or providing for additional delivery units 14 to be sent to the intended destination. This is particularly important in the case of delivering concrete, because concrete tends to harden in the delivery unit 14 during transport, which both reduces the amount of concrete that can be delivered and requires additional cleaning time after delivery.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A method for providing real-time feedback to a concrete delivery unit driver, the method comprising:
a. providing a feedback device in a delivery unit, the feedback device having a display and a wireless transceiver;
b. providing a dispatch system having a wireless transceiver in communication with the feedback device wireless transceiver, a processor configured to allocate time limits to perform at least one driver task, memory, and a data storage, wherein the data storage stores data related to driver tasks;
c. establishing a time limit to complete a task;
d. receiving an indication that the driver is starting a task;
e. transmitting to the feedback device the time limit for the task;
f. displaying on the feedback device an indication of the time remaining to complete the task;
g. if the amount of time remaining is low, displaying on the feedback device an indicator that the time remaining is low;
h. if time has expired, displaying on the feedback device an indication that time is expired;
i. receiving an indication that the driver has completed the task;
j. recording a completion time based on receiving the indication that the driver has completed the task;
j. if time expired before receiving the indication that the driver has completed the task, displaying to the driver a feedback response screen and soliciting from the driver a feedback response indicating the reason for the expiration of time; and
k. recording the completion time and feedback response in the data storage.

2. The method of claim 1, wherein the task performed is selected from a group consisting of going in service, leaving for job site, unloading of concrete, leaving for concrete plant, and clocking out.

3. The method of claim 1, where the indicator that time remaining is low is a color indicator.

4. The method of claim 3, where the color is yellow.

5. The method of claim 1, where the indicator that time has expired is a color indicator.

6. The method of claim 5, where the color is red.

7. The method of claim 1, where the feedback response screen displays a list of potential reasons for the expiration of time.

8. The method of claim 1, where the feedback response screen displays a free response field for the driver to enter a reason for the expiration of time.

9. A method for providing real-time feedback to a concrete delivery unit driver, the method comprising:
a. providing a feedback device in a delivery unit, the feedback device having a display and a wireless transceiver;
b. providing a dispatch system having a wireless transceiver in communication with the feedback device wireless transceiver, a processor configured to allocate time limits to perform at least one driver task, memory, and a data storage, wherein the data storage stores data related to driver tasks;
c. displaying to the driver a time for completing a task, wherein the display indicates when time to complete the task is low or has expired;
d. receiving from the driver an indication that the task has been completed; and
e. recording the time required to perform the task in the data storage.

10. The method of claim 9, where the display changes color to indicate that time to complete a task is low or has expired.

11. The method of claim 9, where the task performed is selected from a group consisting of going in service, leaving for job site, unloading of concrete, leaving for concrete plant, and clocking out.

12. The method of claim 9, further comprising the steps of receiving from the driver a reason that time has expired, and recording the reason in the data storage.

13. A system for providing a driver of a concrete delivery unit with real-time feedback for the performance of tasks, the system comprising:
a dispatch server having a processor, a memory, a data storage, and a wireless transceiver; and
a feedback device in a concrete delivery unit having a display capable of displaying a timer, an input device to receive responses from the driver, and a wireless transceiver in communication with the wireless transceiver of the dispatch server,
wherein the processor is configured to transmit to the feedback device a time to complete a task, to receive information concerning the duration of time to complete the task, and to record the duration of time in the data storage.

14. The system of claim 13, where the task performed is selected from a group consisting of going in service, leaving for job site unloading of concrete, leaving for concrete plant, and clocking out.

15. The system of claim 13, where the display includes indicators to show when time remaining to complete the task is low or has expired.

16. The system of claim 15, where the indicators to show when time is low or has expired are colors.

17. The system of claim 13, where, when time is expired, the feedback device is configured to receive an input from the driver indicating the reason that time has expired.

18. A method for providing real-time feedback to a concrete delivery unit driver, the method comprising:
a. receiving from a central dispatch server a time for completing a task;
b. displaying to the driver a countdown clock for completing the task;
c. providing indicia to the driver if the countdown clock is low or expired;
d. receiving from the driver an indicator that the task is completed; and
e. recording the time required for the driver to complete the task.

19. The method of claim 18, wherein the indicia for indicating the countdown clock is low or expired comprises a visual indicator.

20. The method of claim 19, wherein the visual indicator changes colors when the countdown clock is low, or when the countdown clock is expired.

21. The method of claim 18, wherein the method further comprises receiving a response from the driver if the countdown clock is expired.
